(19) United States
(12) Patent Application Publication
(10) Pub. No.: US 2020/0017228 A1
(43) Pub. Date: Jan. 16, 2020

(54) Parallel Hybrid Aircraft

(71) Applicant: Ampaire, Inc., Temecula, CA (US)

(72) Inventors: Cory Michael Combs, Temecula, CA (US); Jason Nimersheim, Venice, CA (US); Kevin Noertker, Alhambra, CA (US)

(21) Appl. No.: 16/036,760

(22) Filed: Jul. 16, 2018

(51) Int. Cl. B64D 31/06; B64D 27/02

(52) U.S. Cl. CPC B64D 31/06; B64C 11/46; B64D 2027/026; B64D 27/02

(57) ABSTRACT

A parallel hybrid aircraft comprising an electric propulsion system and a combustion propulsion system. The electric propulsion system may include a motor, one or more batteries, and a first propeller. The combustion propulsion system may include a combustion engine and a second propeller. The combustion propulsion system may be decoupled and independently operable from the electric propulsion system. A flight control system may control which of the electric propulsion system and/or the combustion propulsion system provides propulsion and/or thrust for ground movement, takeoff, forward flight at cruising altitude, and/or landing. The flight control system may control the electric propulsion system to provide propulsion and/or thrust to propel the parallel hybrid aircraft on the ground; control both the electric propulsion system and the combustion propulsion system to provide propulsion and/or thrust during takeoff; and/or control the combustion propulsion system to provide propulsion and/or thrust during forward flight at the cruising altitude.

### FIELD

The disclosure relates to a parallel hybrid aircraft.

### BACKGROUND

Electric aircraft have several significant advantages over typical combustion powered aircraft. For example, the emissions (especially on takeoff) and noise pollution of combustion powered aircraft are some of the significant problems solved by electric aircraft. However, existing electric aircraft are typically restricted by heavy battery requirements.

Existing hybrid aircrafts often use both combustion and electric power in series to drive the same propulsion system. These existing hybrid aircraft suffer from efficiency losses in energy conversion. Other existing parallel hybrid aircraft have single propellers with power shared on a single shaft between an electric motor and a hydrocarbon engine.

### SUMMARY

One aspect of the disclosure relates to a parallel hybrid aircraft. The parallel hybrid aircraft may include a multiple propeller aircraft having an electric propulsion system and a combustion propulsion system. The electric propulsion system and the combustion propulsion system may be decoupled. As such, the electric propulsion system and the combustion propulsion system may facilitate a high power differential between takeoff and cruising of the parallel hybrid aircraft. This may enable the parallel hybrid aircraft to have a more efficient operation and increased drag reduction while maintaining a lower weight than existing electric and/or hybrid aircraft.

The parallel hybrid aircraft may include one or more of: a passenger aircraft (e.g., a 4-5 passenger aircraft, a two-passenger aircraft, a business aircraft, a commercial aircraft, etc.), an unpiloted cargo aircraft, a piloted cargo aircraft, an unmanned aircraft (e.g., an unmanned aerial vehicle, etc.), and/or other aircraft.

The parallel hybrid aircraft may comprise a fuselage, an electric propulsion system, a combustion propulsion system, a flight control system, and/or other components. The electric propulsion system may include a motor, one or more batteries, one or more propellers powered by the one or more batteries, the motor, and/or an inverter, and/or other components. By way of non-limiting example, the electric propulsion system may include one or more ducted fans. The combustion propulsion system may include a combustion engine (e.g., a combustion engine), one or more propellers powered by the combustion engine, and/or other components. The combustion propulsion system may be decoupled and independently operable from the electric propulsion system. The one or more propellers powered by the one or more batteries, the motor, and/or an inverter may be discrete and separately operable from the one or more propellers powered by combustion engine.

In some implementations, the combustion propulsion system and/or the electric propulsion system may include one or more of a compressor, diesel engine, a piston engine, a ducted fan, a turbine, a combustor, a mixer, a propeller, a nozzle, and/or other components.

In some implementations, the electric propulsion system may include multiple propellers and/or the combustion propulsion system may include multiple propellers. In some implementations, the one or more propellers powered by the one or more batteries, the motor, and/or the inverter may include a first propeller. The one or more propellers powered by the combustion engine may include a second propeller. In some implementations, the first propeller and/or the second propeller may be coupled to the nose of the parallel hybrid aircraft.

The first propeller may have a first drive shaft and the second propeller may have a second drive shaft. In some implementations, the first drive shaft may be separate and discrete from the second drive shaft. The first propeller and a second propeller may be counter-rotating propellers co-located within the parallel hybrid aircraft. In some implementations, the first propeller and a second propeller may be counter-rotating propellers coupled to the nose of the parallel hybrid aircraft. In some implementations, the first drive shaft and the second drive shaft may be concentric, but not mechanically coupled.

The flight control system may control which of the electric propulsion system and/or the combustion propulsion system provides propulsion and/or thrust during different portions of a flight of the parallel hybrid aircraft. The flight control system may control whether the electric propulsion system and/or the combustion propulsion system provide propulsion and/or thrust for ground movement (e.g., taxiing, etc.), takeoff, forward flight at cruising altitude, and/or landing.

The flight control system may be a mechanical flight control system, a power actuated system, and/or a digital fly-by-wire system. The flight control system may include one or more processors configured by machine-readable instructions, one or more flight control surfaces, one or more controls (e.g., cockpit controls), one or more connecting linkages, one or more operating mechanisms, one or more engine controls, and autopilot system, and/or other components. The flight control systems may comprise one or more flight control systems and/or engine control systems for the electric propulsion system and/or the combustion propulsion system. The flight control systems and/or engine control systems may be integrated or distinct. In traditional planes, flight control and engine control are generally totally separate, while in larger commercial aircraft they are coupled.

The flight control system may be configured to control the electric propulsion system to provide propulsion and/or thrust to propel the parallel hybrid aircraft on the ground. The combustion propulsion system may be idle and/or on standby while the electric propulsion system is providing propulsion and/or thrust to propel the parallel hybrid aircraft on the ground (e.g., before takeoff or subsequent to landing).

The flight control system may be configured to control both the electric propulsion system and the combustion propulsion system to provide propulsion and/or thrust during takeoff of the parallel hybrid aircraft. Both the electric propulsion system and the combustion propulsion system may provide propulsion and/or thrust during takeoff until the parallel hybrid aircraft reaches the cruising altitude. The cruising altitude may be around 3,000-5,000 ft, 11,000-12,000 ft, 34,000-35,000 ft, and/or another cruising altitude that would be known to one of ordinary skill in the art based on the range of the flight, size of the aircraft, and/or function of the aircraft.

The flight control system may be configured to control the combustion propulsion system to provide propulsion and/or thrust during forward flight at the cruising altitude. The electric propulsion system may be in a low-power mode for at least a portion of the forward flight at the cruising altitude. In some implementations, the flight control system may control the electric propulsion system to increase the power provided by the electric propulsion system from a low-power mode to a higher power-mode to supplement the combustion propulsion system and provide propulsion and/or thrust during one or more portions of the forward flight at cruising altitude.

In some implementations, the flight control system may control the combustion propulsion system to provide a limited amount of power sufficient for a threshold speed during forward flight at the cruising altitude. The electric propulsion system may increase the power provided from the low-power mode to supplement the limited amount of power during one or more portions of the forward flight at the cruising altitude. For example, if the parallel hybrid aircraft needs to speed up and/or change altitude, the flight control system may control the electric propulsion system to increase the power provided from the low-power mode to supplement the limited amount of power provided by the combustion propulsion system.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise. As used in the specification and in the claims, the distinctions “first”, “second”, and/or “third” are used for clarity and distinction purposes and do not indicate order unless the context clearly dictates otherwise.

### BRIEF DESCRIPTION OF THE DRAWINGS

FIG. 1 illustrates a side view of a double propeller parallel hybrid aircraft, in accordance with one or more implementations.

FIG. 2 illustrates a side view of a double propeller parallel hybrid aircraft, in accordance with one or more implementations.

FIG. 3 illustrates a top view of a multiple propeller parallel hybrid aircraft, in accordance with one or more implementations.

FIG. 4 illustrates a concentric shaft configuration of two propellers for a double propeller parallel hybrid aircraft, in accordance with one or more implementations.

FIG. 5A illustrates power flow diagram for a double propeller parallel hybrid aircraft, in accordance with one or more implementations.

FIG. 5B illustrates power flow diagram for a multiple propeller parallel hybrid aircraft, in accordance with one or more implementations.

FIG. 5C illustrates power flow diagram for a contra-rotating double propeller parallel hybrid aircraft, in accordance with one or more implementations.

FIG. 6 illustrates a flight profile for a parallel-hybrid aircraft, in accordance with one or more implementations.

FIG. 7 illustrates a flight control system, in accordance with one or more implementations.

FIG. 8 illustrates a method for flying a parallel-hybrid aircraft, in accordance with one or more implementations.

### DETAILED DESCRIPTION

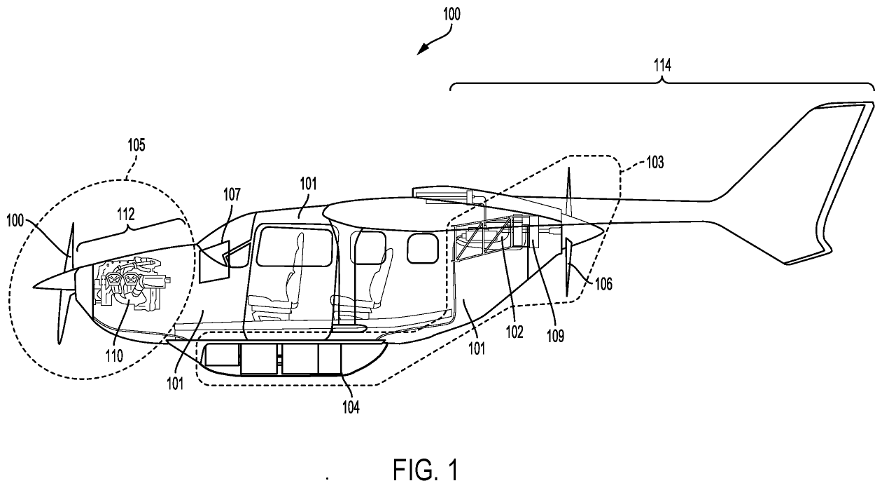

FIG. 1 illustrates a side view of a double propeller parallel hybrid aircraft 100. Parallel hybrid aircraft 100 may include both a combustion propulsion system and an electric propulsion system, wherein the combustion propulsion system and the electric propulsion system are discrete and separately operable. The discrete and separately operable electric propulsion system 103 and combustion propulsion system 105 may facilitate a high power differential between takeoff and cruising that enables parallel hybrid aircraft 100 to operate more efficiently, have a lower weight than existing comparable electric and hybrid aircraft, and/or have increased drag reduction capabilities than existing hybrid aircraft.

Parallel hybrid aircraft 100 may include one or more of passenger aircraft, an unpiloted cargo aircraft, a piloted cargo aircraft, a manned aircraft, an unmanned aircraft, and/or other aircraft configured to transport people and/or items via flight, and/or perform other functions via flight. Parallel hybrid aircraft 100 may comprise a fuselage 101. Fuselage 101 may be the body of parallel hybrid aircraft 100. Fuselage 101 may have a variety of shapes, structures, and/or configurations as would be known to those skilled in the art. Fuselage 101 may be configured to store and/or transport passengers and/or cargo.

Parallel hybrid aircraft 100 may comprise a fuselage 101, an electric propulsion system 103, a combustion propulsion system 105, a flight control system 107, and/or other components. Electric propulsion system 103 may include a motor 102, one or more batteries 104, one or more first propellers 106 powered by the one or more batteries 104, motor 102, and/or an inverter 109, and/or other components. Combustion propulsion system 105 may include a combustion engine 110, one or more second propellers 108 powered by combustion engine 110, and/or other components. The combustion engine 110 may comprise a piston engine, gas engine, turbine engine, diesel engine, and/or other type of propulsion engine. The combustion propulsion system 105 may be discrete and/or separately operable from the electric propulsion system 103. As such, the combustion propulsion system 105 and the electric propulsion system 103 can be operated in independently efficient manners and/or optimized independently for flight regimes suited to the unique strengths of each propulsion system.

The one or more first propellers 106 powered by the one or more batteries 104 may be discrete and separately operable from the one or more second propellers 108 powered by combustion engine 110. In some implementations, a first propeller 106 may have a first drive shaft and/or a second propeller 108 may have a second drive shaft. In some implementations, the first drive shaft may be separate and discrete from the second drive shaft. By way of non-limiting example, the first drive shaft may be separate and discrete from the second drive shaft when the first propeller 106 is located on a different portion (e.g., on the nose and on the tail, on the nose and on the wing(s), on the wing(s) and on the tail, etc.) of parallel hybrid aircraft 100 then the second propeller 108.

In some implementations, the first propeller and a second propeller may be counter-rotating propellers co-located within the parallel hybrid aircraft. In some implementations, the first propeller and a second propeller may be counter-rotating (counter-rotating and/or contra-rotating) propellers coupled to the nose of the parallel hybrid aircraft. In some implementations, the first drive shaft and the second drive shaft may be concentric, but not mechanically coupled.

Combustion propulsion system 105 and/or electric propulsion system 103 may include one or more of a compressor, a turbine, diesel engine, a piston engine, a ducted fan, a combustor, a mixer, a propeller, a nozzle, a battery, an inverter, and/or other components. In some implementations, electric propulsion system 103 may include one or more batteries. Electric propulsion system 103 may include a battery pack. The one or more batteries may be coupled to parallel hybrid aircraft 100. By way of non-limiting example, one or more batteries may be removably coupled to fuselage 101 of parallel hybrid aircraft 100. In some implementations, the one or more batteries may include any electrical charge storage system. By way of non-limiting examples, future technologies for batteries may include super capacitors and/or other technologies.

In some implementations, parallel hybrid aircraft 100 may comprise a retrofitted combustion powered aircraft. Parallel hybrid aircraft 100 may be created by retrofitting the combustion powered aircraft comprising a combustion propulsion system 105 with an electric propulsion system 103. Retrofitting the combustion powered aircraft to create parallel hybrid aircraft 100 may include adapting, augmenting, and/or adding flight control system 107. In some implementations, retrofitting the combustion powered aircraft to create parallel hybrid aircraft 100 may include attaching a battery pack comprising one or more batteries 104 to fuselage 101 of parallel hybrid aircraft 100. By way of non-limiting example, the battery pack comprising one or more batteries 104 may be removably coupled to the belly (or underside) of the parallel hybrid aircraft 101. The battery pack comprising one or more batteries 104 may be replaced quickly after one flight for another flight.

Parallel hybrid aircraft 100 may include a flight control system 107. The flight control system may control which of and/or how much electric propulsion system 105 and/or combustion propulsion system 103 provide propulsion and/or thrust for different portions of a flight. By way of non-limiting example, flight control system 107 may be configured to control the power output of electrical portion system 105 and/or combustion propulsion system 103 based on the flight and/or flight profile. Flight control system 107 may control whether electric propulsion system 105 and/or combustion propulsion system 107 provide propulsion and/or thrust for ground movement, takeoff, forward flight at cruising altitude, and/or landing. Flight control system 107 may control how much power electric propulsion system 103 and/or combustion propulsion system 105 provide while the parallel hybrid aircraft 100 is moving on the ground (e.g., taxiing), taking off, engaging in forward flight at cruising altitude, and/or landing.

In some implementations, the flight control system may be a mechanical flight control system, a manual flight system, a power actuated system, a digital fly-by-wire system, FADEC integration, and/or other flight control system. The flight control system may include one or more processors configured by machine-readable instructions, one or more flight control surfaces, one or more controls (e.g., cockpit controls), one or more connecting linkages, one or more operating mechanisms, one or more engine controls, and autopilot system, and/or other components. In some implementations, the flight control systems may couple the combustion propulsion system and/or the electric propulsion system together to enable dynamic control and/or power balance between the multiple systems (e.g., combustion propulsion system, the electric propulsion system, and/or other systems).

Flight control system 107 may be configured to control electric propulsion system 105 to provide propulsion and/or thrust to propel parallel hybrid aircraft 100 on the ground while taxiing. Parallel hybrid aircraft 100 may utilize electric power for ground movement before takeoff and/or after landing. Combustion propulsion system 105 may be idle and/or on standby while parallel hybrid aircraft 100 is moving on the ground before takeoff and/or after landing. Utilizing electric propulsion system 105, for taxiing may greatly reduce airport noise pollution and/or emissions. Additionally, passengers and airport personnel would be exposed to fewer emissions if the combustion propulsion system 105 was idle while taxiing.

Flight control system 107 may be configured to control both electric propulsion system 103 and combustion propulsion system 105 to provide propulsion and/or thrust during takeoff of the parallel hybrid aircraft. Both electric propulsion system 103 and combustion propulsion system 105 may provide propulsion and/or thrust during takeoff until parallel hybrid aircraft 100 reaches the cruising altitude. The cruising altitude may be around 500-1,000 ft, 1,000-10,000 ft, 3,000-5,000 ft, 11,000-12,000 ft, 20,000-30,000 ft, 34,000-35,000 ft, and/or another cruising altitude that would be known to one of ordinary skill in the art based on the flight range, size of the aircraft, and/or function of the aircraft. In some implementations, cruising altitude may be between 500 feet and 9,000 feet, 9,000 and 20,000 feet, or 20,000 and 45,000 feet. By way of non-limiting example, the cruising altitude may be around 5,000 feet for a General Aviation (GA) aircraft used by private pilots, Part 91/part 135 cargo and passenger flights, drones, hybrid eVTOL, and/or other types of aircraft.

Flight control system 107 may be configured to control combustion propulsion system 105 to provide propulsion and/or thrust during forward flight at the cruising altitude. Electric propulsion system 103 may be in a low-power mode for at least a portion of the forward flight at the cruising altitude. The low-power mode may be between 10% and 25% of the total power of electrical portion system 103. By way of non-limiting example, the low-power mode may be at or below 50 kW power. In some implementations, the low-power mode may be at or near idle and/or standby. By way of non-limiting example, electric propulsion system 103 may be configured to provide low power (e.g., 50 kW or less) during the majority of the forward flight at the cruising altitude.

In some implementations, flight control system 107 may be configured to control electric propulsion system 103 to feather propeller 106, fold propeller 106, and/or stow propeller 106 (to reduce drag) during forward flight at the cruising altitude. Feathering, folding, and/or stowing propeller 106 may enable the aircraft to operate entirely on the combustion propulsion system. If propeller 106 of the electric propulsion system 103 is wind-milling rather than feathered, drag would be high. As such, feathering, folding, and/or stowing propeller 106 is important in the event of electrical system failure for safety, and also for flights where it is desired to stop using battery power (e.g., for a long range ferry flight).

In some implementations, flight control system 107 may control combustion propulsion system 105 to provide a limited amount of power during forward flight at the cruising altitude. The limited amount of power may be sufficient for the parallel hybrid aircraft to travel at or near a threshold speed during forward flight at the cruising altitude. The threshold speed may be set during forward flight at the cruising altitude such that the threshold speed corresponds to a threshold amount of power provided by combustion propulsion system 105. The threshold amount of power may be an efficient power output for combustion propulsion system 105 that balances gas usage with the available electric power for parallel hybrid aircraft 100.

Flight control system 107 may comprise one or more flight control systems and/or engine control systems for electric propulsion system 103 and/or the combustion propulsion system 105. The flight control systems and/or engine control systems may be integrated or distinct. In traditional planes, flight control and engine control are generally totally separate, while in larger commercial aircraft they are coupled. In some implementations, flight control system 107 may be entirely manual, entirely automated, partially manual, and/or partially automated.

Flight control system 107 may be configured to control electric propulsion system 103 to supplement the limited amount of power provided by combustion propulsion system 105 during one or more portions of the forward flight at the cruising altitude. Flight control system 107 may control electric propulsion system 103 to supplement the limited amount of power provided by combustion propulsion system 105 when parallel hybrid aircraft 100 needs to speed up and/or change altitude during forward flight at the cruising altitude. This may enable parallel hybrid aircraft 100 to fly at a speed efficient for combustion propulsion system 105 during forward flight at the cruising altitude, and/or at a faster speed or different altitude when necessary via additional power provided by electric propulsion system 103. As such, parallel hybrid aircraft 100 may operate more efficiently with less weight (e.g., fewer batteries would be required when compared to all electric aircraft, or hybrid aircraft that rely on electric power for forward flight at the cruising altitude) than existing aircraft.

In some implementations, flight control system 107 may be configured to control combustion propulsion system 105 to provide a constant amount of power during takeoff and while cruising at the cruising altitude. Control system 107 may be configured to control electric propulsion system 103 to provide the additional surplus of power required for takeoff.

By way of non-limiting example, flight control system 107 may be configured to control electric propulsion system 103 for provide electric power at or near 100% Max Continuous Power during takeoff. In some implementations, there may be 1.5-2λ more power available from the electric propulsion system 103 for short periods of time (e.g., 10 seconds to a few minutes). In an emergency or for extreme STOL, it may be possible for the electric motor (e.g., motor 102) to operate at 200% power. Motor 102 may also be operated at a lower percentage of max continuous power (for instance on a long runaway where STOL takeoff is not needed) during takeoff.

One or more first propellers 106 powered by the one or more batteries 104, motor 102, inverter 109, and/or other components may be located at or near to the aft 114 of parallel hybrid aircraft 100. One or more first propellers 106 may be coupled to the aft 114 of parallel hybrid aircraft 100.

The one or more second propellers 108 powered by the combustion engine may be located at or near the nose 112 of parallel hybrid aircraft 100. The one or more second propellers 108 may be coupled to the nose 112 of parallel hybrid aircraft 100. In some implementations, the electric propulsion system 103 may include multiple propellers and/or the combustion propulsion system 105 may include multiple propellers. Various propeller configurations are contemplated.

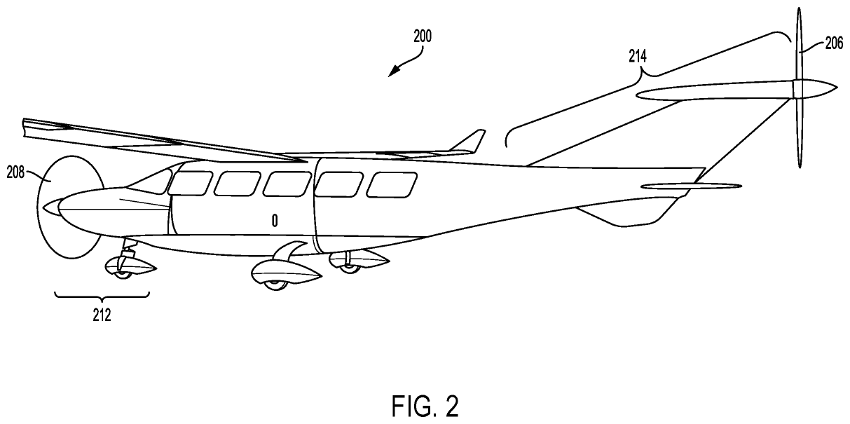

FIG. 2 illustrates a side view of a double propeller parallel hybrid aircraft, in accordance with one or more implementations. Parallel hybrid aircraft 200 may comprise two or more propellers. The two or more propellers may include a first propeller 206 and/or a second propeller 208. First propeller 206 may be powered by an electric motor, inverter, and/or one or more batteries (e.g., the same as or similar to electric motor 102, batteries 104, and/or inverter 109). Second propeller 208 may be powered by a combustion engine (e.g., the same as or similar to combustion engine 110). Parallel hybrid aircraft 200 may include a first propeller 206 located on and/or coupled to a tail portion 214 of parallel hybrid aircraft 200. A second propeller 208 may be located on and/or coupled to a nose portion 212 of parallel hybrid aircraft 200.

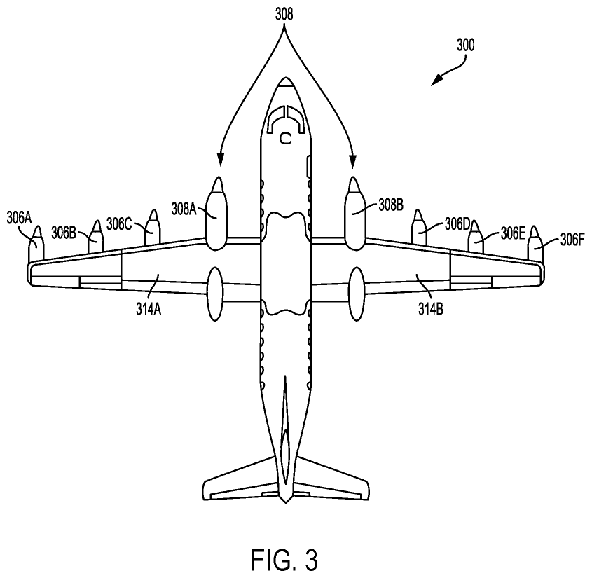

FIG. 3 illustrates a top view of a multiple propeller parallel hybrid aircraft, in accordance with one or more implementations. Parallel hybrid aircraft 300 may include multiple second propellers 308 powered by one or more combustion engines (e.g., the same as or similar to combustion engine 110). Parallel hybrid aircraft 300 may include multiple first propellers 306 powered by one or more electric motors, inverters, and/or batteries (e.g., the same as or similar to electric motor 102, batteries 104, and/or inverter 109). One or more first propellers 306 and/or second propellers 308 may be located on and/or coupled to one or more wings 314 of parallel hybrid aircraft 300. First propellers 306A-C and/or second propeller 308A may be coupled to wing 314A. First propellers 306D-E and/or second propeller 308B may be coupled to wing 314B. In some implementations, first propellers 306D-E may be stowed and/or feathered during forward flight at the cruising altitude.

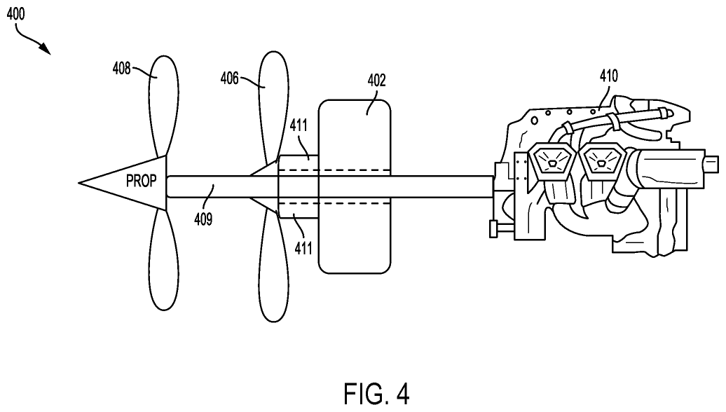

FIG. 4 illustrates concentric shaft configuration of two propellers for a double propeller parallel hybrid aircraft, in accordance with one or more implementations. In some implementations, the parallel hybrid aircraft (the same as or similar to parallel hybrid aircraft 100, 200, and/or 300) may comprise a first propeller 406 and a second propeller 408. Both the first propeller 406 and the second propeller 408 may be coupled to a nose of the parallel hybrid aircraft. The first propeller 406 may have a first drive shaft 411. The second propeller 408 may have a second drive shaft 409. The first propeller 406 may be powered by electric motor 402 via first drive shaft 411. The second propeller 408 may be powered by combustion engine 410 via second drive shaft 409. First drive shaft 411 and second drive shaft 409 may be concentric. In some implementations, first drive shaft 411 and second drive shaft 409 may be concentric but not mechanically coupled. In some implementations, first drive shaft 411 and second drive shaft 409 may be concentric and/or optionally mechanically coupled in order to provide the capability to self-charging as a generator.

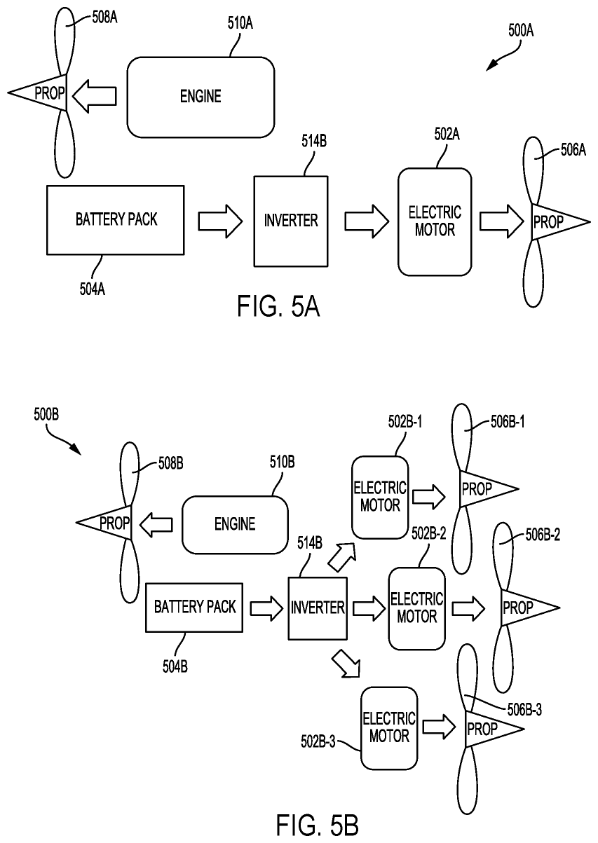

FIG. 5A illustrates power flow diagram for a double propeller parallel hybrid aircraft, in accordance with one or more implementations. Power flow diagram 500A may illustrate engine 510A (e.g., a combustion engine) providing power to propeller 508A. Battery pack 504A, inverter 514A, and/or electric motor 502A, may provide power to propeller 506A. Battery pack 504A, inverter 514A, and/or electric motor 502A may be decoupled from and/or independently operable from engine 510A. Propeller 508A may be discrete and separately operable from propeller 506A.

FIG. 5B illustrates power flow diagram for a multiple propeller parallel hybrid aircraft, in accordance with one or more implementations. Power flow diagram 500B may illustrate engine 510B (e.g., a combustion engine) providing power to propeller 508B. Battery pack 504B, inverter 514B, and/or electric motor 502B-1 may provide power to propeller 506B-1. Battery pack 504B, inverter 514B, and/or electric motor 502B-2 may provide power to propeller 506B-2. Battery pack 504B, inverter 514B, and/or electric motor 502B-3 may provide power to propeller 506B-3. Battery pack 504B, inverter 514B, electric motor 502B-1, electric motor 502B-2, and/or electric motor 502B-3 may be decoupled from and/or independently operable from engine 510A. Propeller 508A may be discrete and separately operable from propeller 506A.

FIG. 5C illustrates power flow diagram for a contra-rotating double propeller parallel hybrid aircraft, in accordance with one or more implementations. Power flow diagram 500C may illustrate engine 510C (e.g., a combustion engine) providing power to propeller 508C. Battery pack 504C, inverter 514C, and/or electric motor 502C, may provide power to propeller 506C. Battery pack 504C, inverter 514C, and/or electric motor 502C may be decoupled from and/or independently operable from engine 510C. Propeller 508C and propeller 506C may be concentric. Propeller 508C may be discrete and separately operable from propeller 506C.

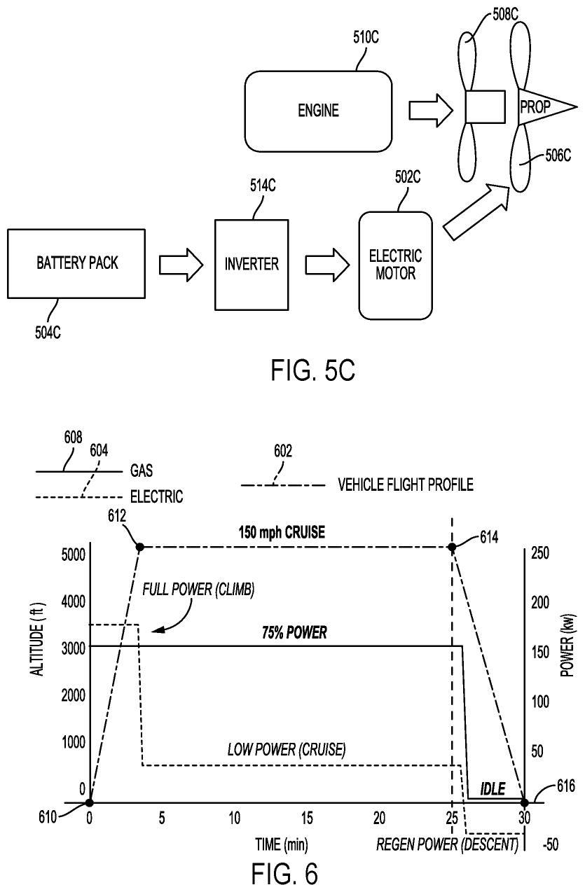

FIG. 6 illustrates a flight profile for a parallel-hybrid aircraft, in accordance with one or more implementations. Flight profile 600 illustrates a flight profile for a parallel hybrid aircraft (e.g., the same as or similar to parallel hybrid aircraft 100, 200, and/or 300). By way of non-limiting example, flight profile 600 may illustrate a flight profile for an example 100 mile flight by a cargo parallel hybrid aircraft.

At takeoff 610, the parallel hybrid aircraft may use both the combustion propulsion system 608 and the electric propulsion system 604. By way of non-limiting example, combustion propulsion system 608 may be used at or near a threshold power level (e.g., 75% of the maximum power) and/or threshold speed (e.g., sufficient for the parallel hybrid aircraft to fly at or near a threshold speed during forward flight at cruising altitude). Electric propulsion system 604 may be used at or near full power during takeoff until the parallel hybrid aircraft reaches the cruising altitude 612.

At the cruising altitude 610, the combustion propulsion system 608 may maintain the threshold power level and/or speed. Electric propulsion system 604 may go into a low-power mode while the parallel hybrid aircraft is in forward flight at the cruising altitude 612. In some implementations (not illustrated in FIG. 6), electric propulsion system 604 may supplement the combustion propulsion system 608 above a low-power mode during forward flight at the cruising altitude 612 responsive to the parallel hybrid aircraft needing to increase its speed and/or change altitude. As such, combustion propulsion system 608 may remain at an efficient power level for the flight and/or electric propulsion system 604 may only be used in a low power mode and/or in a higher power mode when necessary.

At or near the initial descent 614 of the parallel hybrid aircraft, the combustion propulsion system 608 may switch to an idle mode. The electric propulsion system 604 may switch into a regenerative power mode during descent of the parallel hybrid aircraft. The parallel hybrid aircraft may regenerate power via the electric propulsion system during the descent and/or upon landing. Once on the ground at 616, the electric propulsion system 604 may be used to provide power for taxiing 618.

In some implementations, by way of non-limiting example, the electric motor and combustion engine may be clutched together after landing when they are co-located in order to generate power for self-recharge.

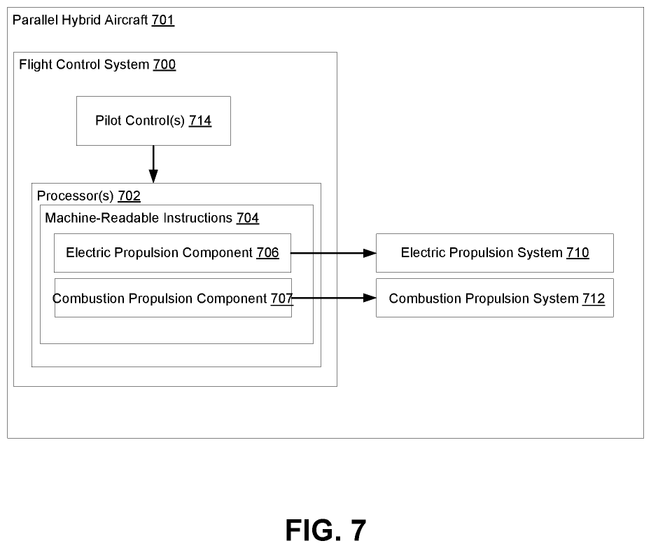

FIG. 7 illustrates a flight control system, in accordance with one or more implementations. Flight control system 700 for parallel hybrid aircraft 701 may include one or more processors 702. One or more processors 702 may be configured by machine-readable instructions 704 to execute one or more components. Electric propulsion component 706 may be configured to control electric propulsion system 710. Combustion propulsion component 707 may be configured to control combustion propulsion system 712. Flight control system 700 may be configured to receive input via one or more pilot controls 714.

Electric propulsion component 706 may be configured to control electric propulsion system 105 to provide propulsion and/or thrust to propel parallel hybrid aircraft 701 on the ground while taxiing. Electric propulsion component 706 may be configured to control electric propulsion system 710 to provide propulsion and/or thrust during takeoff of parallel hybrid aircraft 701. Electric propulsion component 706 may be configured to control electric propulsion system 710 to maintain a low-power mode for at least a portion of the forward flight at the cruising altitude. In some implementations, electric propulsion component 706 may be configured to control electric propulsion system 710 to supplement (above the low-power mode) the limited amount of power provided by combustion propulsion system 712. Electric propulsion component 706 may be configured to control electric propulsion system 710 to stop providing power (e.g., become idle) responsive to parallel hybrid aircraft 701 initiating its descent. Electric propulsion components 706 may be configured to control electric propulsion system 710 to capture regenerative power during descent and/or landing of parallel hybrid aircraft 701.

Combustion propulsion component 707 may be configured to control combustion propulsion system 712 to provide propulsion and/or thrust during takeoff of the parallel hybrid aircraft 701. Combustion propulsion component 707 may be configured to control combustion propulsion system 712 to provide a limited amount of power during forward flight of parallel hybrid aircraft 701 at the cruising altitude. The limited amount of power may be sufficient for parallel hybrid aircraft 701 to travel at or near a threshold speed during forward flight at the cruising altitude. Combustion propulsion component 707 may be configured to control combustion propulsion system 712 to stop providing power (e.g., become idle) responsive to parallel hybrid aircraft 701 initiating its descent.

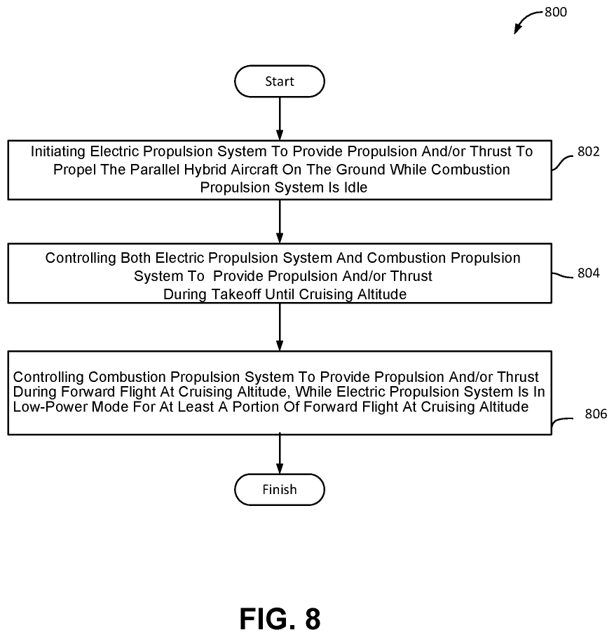

FIG. 8 illustrates a method for flying a parallel-hybrid aircraft, in accordance with one or more implementations. The operations of method 800 presented below are intended to be illustrative. In some embodiments, method 800 may be accomplished with one or more additional operations not described, and/or without one or more of the operations discussed. Additionally, the order in which the operations of method 800 illustrated in FIG. 8 and described below is not intended to be limiting.

In some embodiments, method 800 may be implemented by one or more components of a parallel hybrid aircraft including. The one or more components of a parallel hybrid aircraft may include a fuselage, one or more wing(s), a nose portion, a tail portion, an electric propulsion system, a combustion propulsion system, a flight control system, and/or other components.

At an operation 802, the electric propulsion system may be initiated to provide propulsion and/or thrust to propel the parallel hybrid aircraft on the ground while the combustion propulsion system is idle. The electric propulsion system may include a motor, one or more batteries, and a first propeller. The combustion propulsion system may include a combustion engine and/or a second propeller. In some implementations, operation 802 may be performed by a flight control system the same as or similar to flight control system 107 and/or flight control system 700 (shown in FIGS. 1 and 7 and described herein).

At an operation 804, both the electric propulsion system and the combustion propulsion system may be controlled to provide propulsion and/or thrust during takeoff. Both the electric propulsion system and the combustion propulsion system may be controlled to provide propulsion and/or thrust during takeoff until the parallel hybrid aircraft reaches a cruising altitude. In some implementations, operation 804 may be performed by a flight control system the same as or similar to flight control system 107 and/or flight control system 700 (shown in FIGS. 1 and 7 and described herein).

At an operation 806, the combustion propulsion system may be controlled to provide propulsion and/or thrust during forward flight at the cruising altitude. The electric propulsion system may be in low-power mode for at least a portion of the forward flight at cruising altitude. The combustion propulsion system may be decoupled and/or independently operable from the electric propulsion system. As such, the first propeller may be discrete from the second propeller. In some implementations, operation 806 may be performed by a flight control system the same as or similar to flight control system 107 and/or flight control system 700 (shown in FIGS. 1 and 7 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A parallel hybrid aircraft, the parallel hybrid aircraft comprising:
a fuselage;
an electric propulsion system including a motor, one or more batteries, and a first propeller;
a combustion propulsion system including a combustion engine and a second propeller, wherein the combustion propulsion system is decoupled and independently operable from the electric propulsion system such that the first propeller is discrete and separately operable from the second propeller; and
a flight control system that controls which of the electric propulsion system and/or the combustion propulsion system provides propulsion and/or thrust for ground movement, takeoff, and forward flight at cruising altitude, wherein the flight control system is configured to:
control the electric propulsion system to provide propulsion and/or thrust to propel the parallel hybrid aircraft on the ground while the combustion propulsion system is idle;
control both the electric propulsion system and the combustion propulsion system to provide propulsion and/or thrust during takeoff until the cruising altitude is reached by the parallel hybrid aircraft; and
control the combustion propulsion system to provide propulsion and/or thrust during forward flight at the cruising altitude, while the electric propulsion system is in a low-power mode for at least a portion of the forward flight at the cruising altitude.

2. The system of claim 1, wherein the flight control system controls the electric propulsion system to supplement the combustion propulsion system and provide propulsion and/or thrust during one or more portions of the forward flight at cruising altitude.

3. The system of claim 1, wherein the flight control system controls the combustion propulsion system to provide a limited amount of power sufficient for a threshold speed during forward flight at the cruising altitude, and wherein the electric propulsion system supplements the limited amount of power during one or more portions of the forward flight at the cruising altitude.

4. The system of claim 1, wherein the first propeller and/or the second propeller are coupled to a nose of the parallel hybrid aircraft.

5. The system of claim 4, wherein the first propeller and the second propeller are counter rotating propellers coupled to the nose of the parallel hybrid aircraft.

6. The system of claim 1, wherein the first propeller and/or the second propeller are coupled to the aft fuselage of the parallel hybrid aircraft and/or a tail of the parallel hybrid aircraft.

7. The system of claim 1, wherein the electric propulsion system includes multiple propellers and/or the combustion propulsion system includes multiple propellers.

8. The system of claim 1, wherein the first propeller has a first drive shaft and the second propeller has a second drive shaft, and wherein the first drive shaft and the second drive shaft are separate and discrete.

9. The system of claim 1, wherein the first propeller has a first drive shaft and the second propeller has a second drive shaft, and wherein the first drive shaft and the second drive shaft are concentric but not mechanically coupled.

10. The system of claim 1, wherein the combustion propulsion system and/or the electric propulsion system includes a compressor, a turbine, a diesel engine, a piston engine, a ducted fan, a combustor, a mixer, and/or a nozzle.

11. A method for controlling flight via a parallel hybrid aircraft having an electric propulsion system and a combustion propulsion system, the method comprising:
initiating the electric propulsion system, including a motor, one or more batteries, and a first propeller, to provide propulsion and/or thrust to propel the parallel hybrid aircraft on the ground while the combustion propulsion system, including a combustion engine and a second propeller, is idle;
controlling both the electric propulsion system and the combustion propulsion system to provide propulsion and/or thrust during takeoff until a cruising altitude; and
controlling the combustion propulsion system to provide propulsion and/or thrust during forward flight at the cruising altitude, while the electric propulsion system is in low-power mode for at least a portion of the forward flight at cruising altitude,
wherein the combustion propulsion system is decoupled and independently operable from the electric propulsion system such that the first propeller is discrete from the second propeller.

12. The method of claim 11, further comprising regenerating, via the electric propulsion system, electric power during landing of the parallel hybrid aircraft while the combustion propulsion system is idle.

13. The method of claim 11, further comprising controlling the electric propulsion system to supplement the combustion propulsion system and provide propulsion and/or thrust during one or more portions of the forward flight at the cruising altitude.

14. The method of claim 11, further comprising controlling the combustion propulsion system to provide a limited amount of power sufficient for a threshold speed during forward flight at the cruising altitude, and wherein the electric propulsion system supplements the limited amount of power during one or more portions of the forward flight.

15. The method of claim 11, wherein the cruising altitude is between 500 feet and 9,000 feet, 9,000 and 20,000 feet, or 20,000 and 45,000 feet.

16. The method of claim 11, wherein the electric propulsion system includes multiple propellers and/or the combustion propulsion system includes multiple propellers.

17. The method of claim 11, wherein the first propeller and/or the second propeller are coupled to a nose, aft fuselage, and/or tail of the parallel hybrid aircraft.

18. The method of claim 11, wherein the first propeller has a first drive shaft and the second propeller has a second drive shaft, and wherein the first drive shaft and the second drive shaft are separate and discrete.

19. The method of claim 11, wherein the first propeller has a first drive shaft and the second propeller has a second drive shaft, and wherein the first drive shaft and the second drive shaft are concentric but not mechanically coupled.

20. The method of claim 11, wherein the combustion propulsion system and/or the electric propulsion system includes a compressor, a turbine, a diesel engine, a piston engine, a ducted fan, a combustor, a mixer, and/or a nozzle.
